(19) United States
(12) Patent Application Publication
(10) Pub. No.: US 2023/0109533 A1
(43) Pub. Date: Apr. 6, 2023

(54) MEMORY USAGE HINTS BETWEEN A PROCESSOR OF A SERVER AND A NETWORK INTERFACE DEVICE

(71) Applicant: Intel Corporation, Santa Clara, CA (US)

(72) Inventors: Daniel Biederman, Saratoga, CA (US); Israel Ben-Shahar, Mevaseret Zion (IL); Filip Schmole, Portland, OR (US)

(21) Appl. No.: 18/064,582

(22) Filed: Dec. 12, 2022

(51) Int. Cl. G06F 3/06

(52) U.S. Cl. CPC G06F 3/0656; G06F 3/0613; G06F 3/067

(57) ABSTRACT

Systems, apparatuses, and methods provide for memory management. Communications with a network interface device are paced to provide memory management. An incoming message is received, via the network interface device, including a hint from a processor of a server via a bi-directional stream. The hint includes buffer space type data and/or buffer space available data. A transfer rate of outgoing messages communicated via the bi-directional stream is adjusted in response to the hint, via the network interface device.

### TECHNICAL FIELD

Embodiments generally relate to packet processing between a consumer and a producer. More particularly, embodiments relate to packet processing between a processor of a server and a network interface device.

### BACKGROUND

Smart network interface controllers (SmartNICs) have been gaining popularity in recent times. In particular, such SmartNICs technologies have been introduction in cloud environments. For example, some SmartNICs can help offload certain tasks from central processing units (CPUs). Similarly, infrastructure processing units (IPU) offer a programmable networking device designed for cloud and communication service providers to reduce overhead and free up performance for CPUs.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example computing platform according to an embodiment;

FIG. 2 is an illustration of another example of a computing platform according to an embodiment;

FIG. 3 is an illustration of an example memory structure according to an embodiment;

FIG. 4 is an illustration of example computing platform architectures according to an embodiment;

FIG. 5 is a flowchart of an example method of packet processing between a consumer and a producer according to an embodiment;

FIG. 6 is a flowchart of a further example method of packet processing between a consumer and a producer according to an embodiment; and

FIG. 7 is an illustration of an example of a semiconductor package apparatus according to an embodiment.

### DESCRIPTION OF EMBODIMENTS

Infrastructure processing unit (IPU) solutions are often limited to process data as fast as the network speed. In some cases, IPUs are proactive, and pace data at a rate of consumption. Running at the network speed on ingress means that a central processing unit (CPU) could get microbursts of data that could result in data being placed in the wrong location (slow memory/host memory versus fast memory/cache). However, being proactive means that at times, the IPU may underflow the CPU's memory. This can lead to idle processing cycles and memory misses, reducing CPU performance.

In current technologies, DATA DIRECT I/O (DDIO) currently is typically limited to a small portion of the L3 cache and it does not include any occupancy feedback. If the L3 cache overflows, the L3 cache would spill into host memory which is slow. DDIO could easily overflow lower-level cache, as there is no occupancy feedback of a lower-level cache (L1 or L2) or memory structure (register file).

In other current technologies, cache Quality of Service (QoS) attempts to allow certain items to stay in cache for longer periods of time based on their “Quality of Service” or limit area those cache items can be located. For example, an application may have a certain area of cache reserved, but any data beyond that area would be forced into the slower host memory.

As will be described in greater detail below, some implementations described herein will act in a proactive manner. In some implementations, an IPU paces the data such that CPU will rarely overflow and rarely underflow the buffer (or cache).

As will be described in greater detail below, in some of the implementations described herein, communications performed with a network interface device are paced to provide memory management. For example, an incoming message is received, via the producer (e.g., a network interface device), including a hint from a consumer (e.g., a processor of a server) via a bi-directional stream. The hint includes buffer space type data and/or buffer space available data. A transfer rate of outgoing messages communicated via the bi-directional stream is adjusted in response to the hint (e.g., via the network interface device), for example.

In some implementations, for each bi-directional stream (e.g., IPU queue) between the CPU and IPU, a hint is added to the message going to the IPU that indicates the buffer space type (fast/slow) (in some examples there may only be one buffer space in small memories, like an L1 cache, FIFO or Register file, etc.) and size available for messages incoming from IPU. Advantageously, this will allow the IPU to increase or decrease the rate of incoming data to try to maximize the buffer space and minimize the risk of overflow or underflow.

Additionally, or alternatively, in some examples, a hint is sent from the CPU's memory management unit on the occupancy of a low-level memory structure like a L1 cache, L2 cache, register file or FIFO. Similarly, in some implementations, a hint is sent between a memory centric device and an IPU/NIC that allow occupancy levels to be communicated.

Advantageously, as will be described in greater detail below, in some of the implementations described herein manage CPU (or other consumer device) data to constantly fill a memory area without overflowing into a slower memory or underflowing the same memory when data is available for it. This can lead to Just-in-Time data delivered to the CPU low level cache or memory structure, to minimize or remove cache misses and the performance penalties that may occur with cache misses.

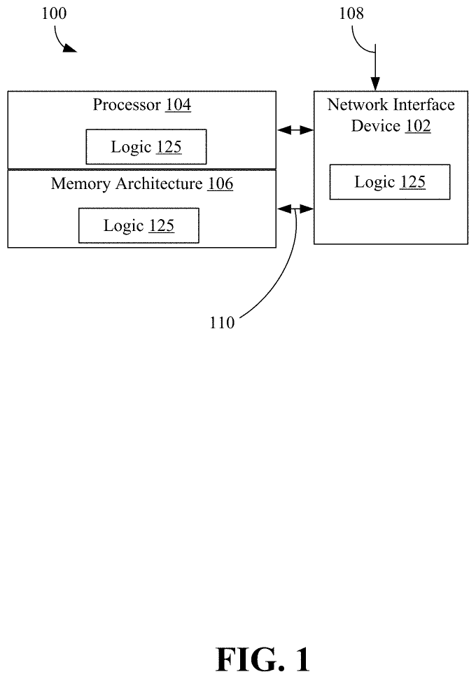

FIG. 1 is a block diagram of an example computing platform 100 according to an embodiment. In the illustrated example, the computing platform 100 includes one or more network interface devices 102 (e.g., an infrastructure processing unit, which is one illustration of a producer device, as will be discussed in greater detail below) in communication with a memory architecture 106 communicatively coupled to a processor 104 (e.g., a processor of a server, which is one illustration of a consumer device).

In some examples, the computing platform 100 is embodied as a server. Additionally, or alternatively, the techniques described herein are applicable to any type of electronic device in a variety of configurations and form factors for performing the functions described herein. For example, the computing platform 100 is implementable as, without limitation, a smart phone, a tablet computer, a wearable computing device, a laptop computer, a notebook computer, a mobile computing device, a cellular telephone, a handset, a messaging device, a vehicle telematics device, a server computer, a workstation, a distributed computing system, a multiprocessor system, a consumer electronic device, the like, and/or any other computing device configured to perform the functions described herein. Similarly, the techniques described herein are applicable to any type of accelerator for performing the functions described herein. For example, such an accelerator is implementable as, without limitation, a central processing unit (CPU), a graphics processing unit (GPU), an Associative Processing Unit (APU), a Tensor Processing Unit (TPU), an Encryption Engine, the like, and/or combinations thereof.

As will be described in greater detail below, the network interface device 102 receives one or more incoming packets of memory traffic 108. For example, network interface device 102 determines when and where to route the one or more incoming packets of memory traffic 108.

As illustrated, communication between the network interface device 102 and the processor 104, and/or between the network interface device 102 and the memory architecture 106, is accomplished through a plurality of bi-directional streams 110. For example, one or more bi-directional streams 110 (e.g., IPU queue) are utilized between the processor 104 (e.g., CPU) and the network interface device 102 (e.g., IPU). In some implementations, such bi-directional streams may involve a single Compute Express Link (CXL) or Peripheral Component Interconnect express (PCIe) interface (or the like) that covers multiple processors and/or memory architectures.

In some implementations, as used herein the term “processor” refers to consumer of information (e.g., data and/or instructions), including a central processing unit (CPU), a graphics processing unit (GPU), an accelerator, the like, and/or combinations thereof. For example, the processor 104 is implementable on any properly configured processing unit, including, without limitation, one or more mobile application processors, one or more desktop or server central processing units including multi-core central processing units, one or more parallel processing units, as well as one or more graphics processors or special purpose processing units, without departure from the scope of the examples described herein.

In some examples, as used herein the term “network interface device” refers to a producer of information (e.g., data and/or instructions), including a network interface controller (NIC), a smart network interface controller (SmartNIC), a reconfigurable SmartNIC, an infrastructure processing unit (IPU), a Data Processing Unit (DPU), the like, and/or combinations thereof. In such an implementation, the network interface device 102 typically includes a processor in addition to a network interface, such that the network interface device 102 is able to perform one or more compute functions.

In some examples, the network interface device 102, the processor 104, and/or the memory architecture 106 include logic 125. The logic 125 is implementable via transistor array, other integrated circuit/IC components, the like, and/or combinations thereof. Additionally, or alternatively, the logic 125 is implementable in one or more modules as a set of logic instructions stored in a machine- or computer-readable storage medium such as random access memory (RAM), ROM, programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

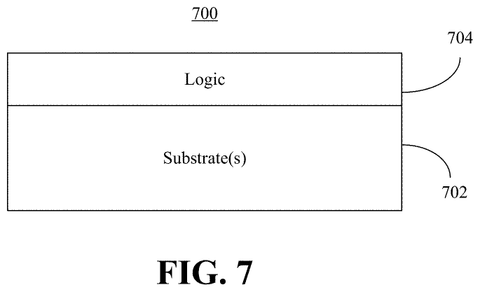

For example, the logic 125 of the network interface device 102 is integrated onto a semiconductor die, as will be discussed in greater detail below with respect to FIG. 7. Similarly, all of the computing platform 100 is capable of being implemented in a single application-specific integrated circuit (ASIC) (e.g., s server ASIC that has an integrated network interface controller (NIC)), or different chiplets in a single chip/server. For example, such a computing platform 100 is capable of being implemented in a field programmable gate array (FPGA) that has processors with a low level memory (e.g., L1, FIFO, or the like) and a network interface.

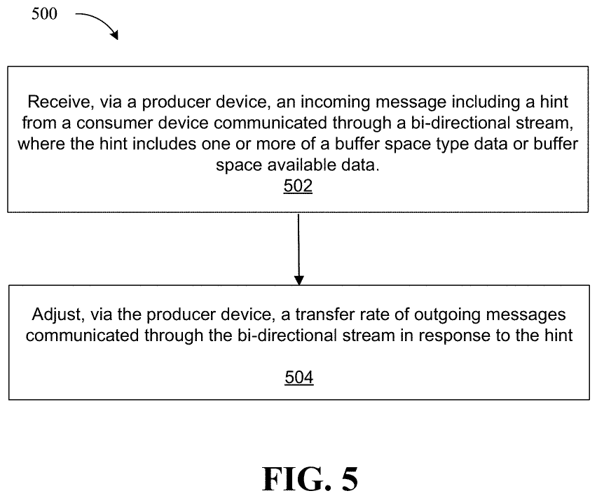

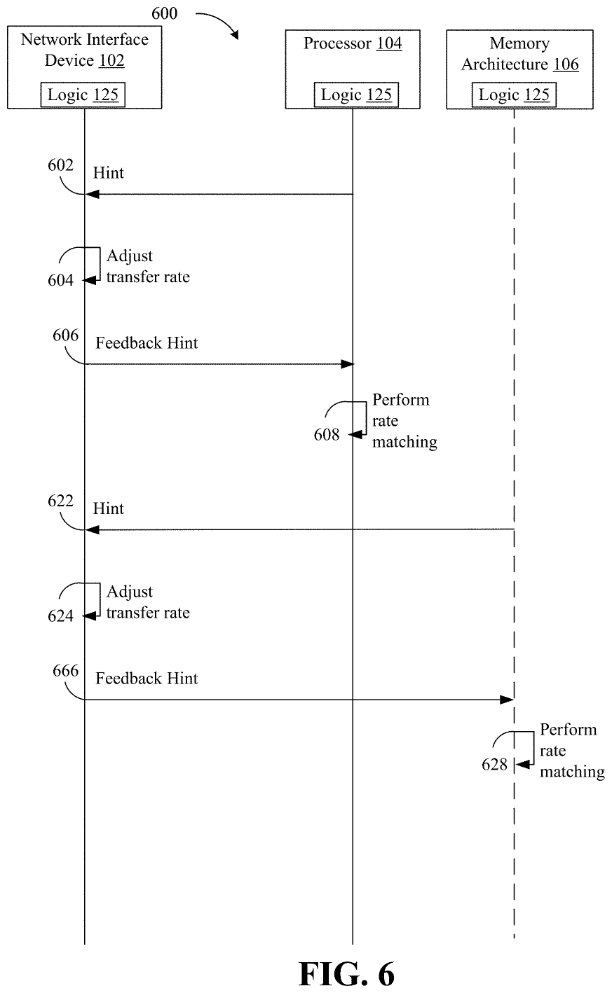

In some examples, the logic 125 of the network interface device 102, which may include one or more of configurable or fixed-functionality hardware, is configured to perform one or more aspects of the method 500 (FIG. 5) and/or the method 600 (FIG. 6), which are discussed in more detail below.

Additionally, or alternatively, memory architecture 106 and/or processor 104 may also include logic 125, which has corresponding functionality as the logic incorporated into the network interface device 102.

As will be described in greater detail below, in some implementations, for each bi-directional stream 110 (e.g., IPU queue) between the processor 104 (e.g., CPU) and the network interface device 102 (e.g., IPU), a hint is added to a message going to the network interface device 102 that indicate the buffer space type (fast/slow) and size available for messages incoming from the network interface device 102. Such operations permit the network interface device 102 to increase or decrease the rate of incoming data to try to maximize the buffer space and minimize the risk of overflow or underflow, for example.

In some implementations, as used herein the term “hint” refers to one or multiple hints associated with an individual message, that are is more than 1 bit in size (e.g., 2 bits, 3 bits, less than 8 bits, etc.), where the one or multiple hints are included in the message itself or include outside the message (e.g., as meta data, preamble type data, the like, and/or combinations thereof). For example, the hint includes a rate, a rate adjustment, the like, and/or combinations thereof. Additionally, or alternatively, in some implementations, the hint is a credit return.

In some implementations, the memory usage hints are described as being between a producer and consumer. For example, as used herein the term “producer” and/or “producer device” refers to a network interface, a system-on-a-chip (SoC) interconnect for the connection and management of functional blocks on-chip (e.g., Advanced Microcontroller Bus Architecture (AMBA) network Interconnect or the like), a direct GPU-to-GPU interconnect (e.g., NVLink), the like, and/or combinations thereof. Similarly, as used herein the term “consumer” and/or “consumer device” refers to a device that performs operations on information transferred from the producer, such as a processor, the like, and/or combinations thereof.

As will be discussed in greater detail below, the hints discussed herein improve performance. For example, the hints discussed herein are capable of (a) directing the data as close as possible to the specific physical structure (e.g., buffer/cache/FIFO/register file) in the consumer where the consumer is most quickly/efficiently able to consume the data, and (2) pacing, (e.g., to ensure that the producer does not overwhelm this physical structure), which will cause the data to spill into other, more distant structures away from the most ideal structure in the consumer.

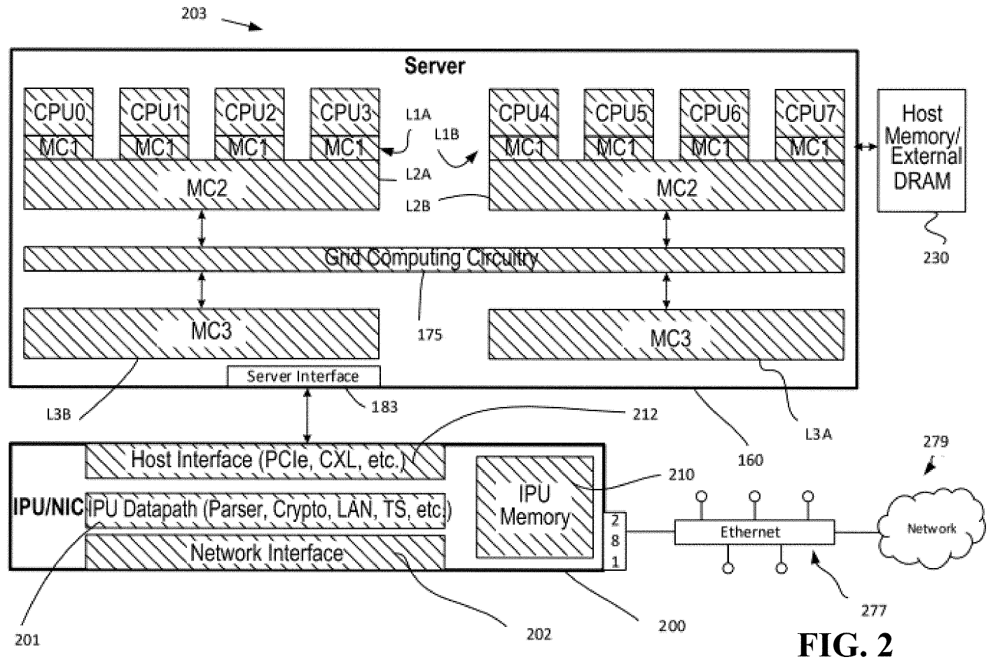

Additional and/or alternative details regarding the computing platform 100 are described in greater detail below in the description of FIGS. 2-4.

FIG. 2 shows another example computing platform 203 according to an embodiment, the computing platform for example being a computer system of a data center. The computing system 202 includes a server architecture 260 coupled to a host memory 230 and to a network interface device 200.

A server architecture may include any number of subsystems with each subsystem including any number of computing units (e.g., CPUs) and any number of associated memory circuitries (e.g., caches) in any configuration. In addition, the use of a grip computing circuitry, such as a grid computing circuitry, or other similar grid computing technology is optional.

The server architecture may include a packet processing device interface 183 using at least one of Peripheral Component Interconnect (PCI), PCI express (PCIe), PCIx, Universal Chiplet Interconnect Express (UCIe), Intel On-chip System Fabric (IOSF), Gen-Z, Open Coherent Accelerator Processor Interface (OpenCAPI), Compute Express Link (CXL), Serial ATA, USB compatible interface, AMBA®, NVLink, the like, and/or combinations thereof. Interface 183 is to couple the server architecture to a network interface device to receive signals therefrom, such as data and/or instructions.

In the illustrated example, server architecture 260 is shown to include, respectively, memory circuitries 1 (MC1's), MCs 2 and MCs 3. A MC1, MC2 or MC3, as shown in FIG. 2, is to include a memory structure which may include at least one of a, respectively, L1, L2 or L3 cache, an instruction cache, a data cache, a first in first out (FIFO) memory structure, a last in first out (LIFO) memory structure, a Time sensitive/time aware memory structure, a ternary content-addressable memory (TCAM) memory structure, a register file such as a nanoPU device, the like, and/or combinations thereof. IN some implementations herein, a MC1, MC2 or MC3 as referred to herein may include any of the above non-cache memory structured carved out of a, respectively, L1, L2 or L3 cache, or separate from the L1, L2 or L3 cache. The MC3 cache, in the depicted example, are shown as being coupled to their respective MC2 caches L2A and L2B by way of a grid computing circuitry 175 (e.g., a UNCORE (Uniform Interface to Computing Resources)).

As illustrated, the distance between all the memory locations to a single CPU is not equal. The longer the distance between the CPU to use the data and the storage location of such data, the more power. Access distance, in the context of a computing unit accessing a memory circuitry, refers to the power consumption required for the computing unit to access data within the memory circuitry. The access distance is based in part on a physical wiring distance between the CPU and the memory circuitry. The above is especially significant for 3-dimensional chips/chiplets or stacked dies, where, although a CPU may be a distance x away from the desired memory circuitry in which data is to be accesses, the wiring between the CPU and the memory circuitry may be a total length y, where y may be far larger than x. The access distance may further be based on pipeline stages to access the data, or to barriers (such as chiplet boundaries, number of buffers, number of interfaces, etc.) that use more power to be crossed.

In some implementations, the network interface device 200 includes an IPU by way of example. For example, network interface device 200 has a network interface 281 which is connected to Ethernet 277. The Ethernet 277 may connect the computing platform 203 to a network 279 including client devices (not shown). At the other end of the IPU, a host interface 212 may connect the IPU with the server architecture 160 using Peripheral Component Interconnect (PCI) or Compute Express Link (CXL), for example through a corresponding PCI or CXL interface 183, or the like. Between the network interface 281 and the host interface 212, packet processing circuitry 201 processes and routes the data packets received by the network interface device 200 by way of Ethernet 277 from the network 279. The packet processing circuitry 201 may implement, for example, a FleXible Parser (FXP), or one or more of many different other protocols (e.g., RDMA, NVMe, Encryption, etc.) as well as packet storage and decryption. In the ingress direction, packet processing circuitry 201 may be configured to place the data at various locations in the host memory 230.

In some implementations, the network interface device 200 is physical location aware. The network interface device 200 may be physical location aware by, for example, determining the physical location based on a physical location of one or more computing units (e.g., processors) that are to execute a workload based on the data packet (e.g., one or more “requesting computing units”). The physical location of a memory circuitry refers to a physical portion of the circuitry where the data from the data packet is to be stored. A “requesting computing unit” as referred to herein refers to a physical processor circuitry that is to execute a workload based on a given data packet that has been requested for execution of the workload, or to a virtual machine, container, or operating system on the physical processing circuitry that has requested the data packet for execution of the workload.

In the illustrated example, the network interface device 200 includes built-in computing units 201 and processing elements and a close-cooperation interface 212 with the server architecture 160. In some implementations the network interface device 200 is adapted to use knowledge about various conditions in the computing system (e.g., both the state of the network interface device 200 itself and/or the operational state of the server architecture) to manage data routing operations on data packets being received from Ethernet 277. Such data routing operations include routing data from data packets received from the network to various physical locations of caches within server 160 in order to make the performance of the server more efficient and more reliable. In some implementations, the network interface device 200 includes an IPU that includes processors and cache. Similarly, SmartNICs typically have a software programmable path that utilize a pool of CPUs, while a basic NIC may not have such processors.

As will be described in greater detail below, in the CPU/GPU/Accelerator to IPU/NIC direction, a memory in the CPU/GPU/Accelerator could have a given size that is reserved for a certain function, like processing a packet, meta data, a flow's information, a microservice, a database query, the like, and/or combinations thereof, for example. In some examples, this memory could be in the L1 cache, L2 cache, or a dedicate structure like a FIFO or register file (e.g., the nanoPU), and/or the like. A hint from the CPU's memory management unit on the occupancy of a low-level memory could be given back to the IPU on every transaction from the CPU/GPU/Accelerator. Thus, allowing the important data to arrive Just-in-Time and rarely overflow the CPU's memory structure or area of CPU memory assigned for this purpose (e.g., L1 cache, L2 cache, FIFO, register structure, and/or the like).

In some implementations, such a mechanism will often need to correctly manage the placement of incoming IPU data at the various memory types, as the IPU can now control the data rate and match the rate of data consumption by the processor or accelerators. Such rates across the PCIe and CXL interfaces could be as high as Terabits per Second. Well beyond what is typical in existing usages.

In some examples, such mechanism as described herein could be applied to both data and instructions. For example, when the IPU plans to provide data for the CPU at specific time, the instructions or program that are needed to process this data could be fetched at time from memory to cache. To perform such fetching, such an IPU would parse the incoming data and understand the associated processing requirements. Then such an IPU is capable of loading the associated instructions/routines into the cache so the associated instructions/routines are ready to process the data upon arrival. Such a technique may involve the IPU telling the processor's memory management unit what to do and/or involve the memory management unit allowing the IPU to do the fetch for the memory management unit.

In some implementations, such a mechanism as described herein could apply to traditional memory structure (e.g., L1 cache, L2 cache, or Last Level Cache) or a subset of that structure. Additionally, or alternatively, such a mechanism could apply to new memory types and algorithms like FIFOs and Register files, time-aware memories, and time-aware caching algorithms. In one example of a cache algorithm, in an ideal case, such a mechanism as described herein could apply at the exact time it should take the processor to use the data. In another example, a least recently used (LRU algorithm) may use the precise time to determine when eviction can occur. In a further example, the IPU programs the expected eviction time possibly using least recently used bits.

In some examples, such a mechanism as described herein could be implemented in a memory centric system. In such a memory centric system, there would be layers of memory that could include a register file, L1, L2 and L3 cache, then host memory, SSD, and hard drives, for example. In such an example, occupancy hints could be used to communicate occupancy to an IPU/NIC to better manage the data rate to the different types of memories.

In some implementations, for the hints described herein to be successful, such hints would understand consumption rates and/or the expected amount of data to be consumed by a CPU over time. Hence the memory structures could be time aware, in some implementations.

Additionally, or alternatively, feedback hints may be sent from a producer device to a consumer device. For example, feedback hints may be sent from the IPU to the CPU. In response, rate matching/pacing may occur at the CPU based on such feedback hints.

Additionally, or alternatively, an endpoint device may provide hints to a consumer (e.g., the CPU), indicating the “destination” for a memory write transaction. In such an example, such a “destination” could mean a specific level of cache, register files, memory, or the like. For example, such a destination hint could be implemented (e.g., using Standard PCIe/CXL steering tags) to identify the destination of producer to consumer (e.g., the IPU to CPU) transfer. For example, such a destination hint could indicate an L2 cache or other memory structures, like a FIFO or register file. Additionally, or alternatively, such a destination hint could be implemented via a Virtual Destination Handle or Quality of Service Identifiers (QoS IDs).

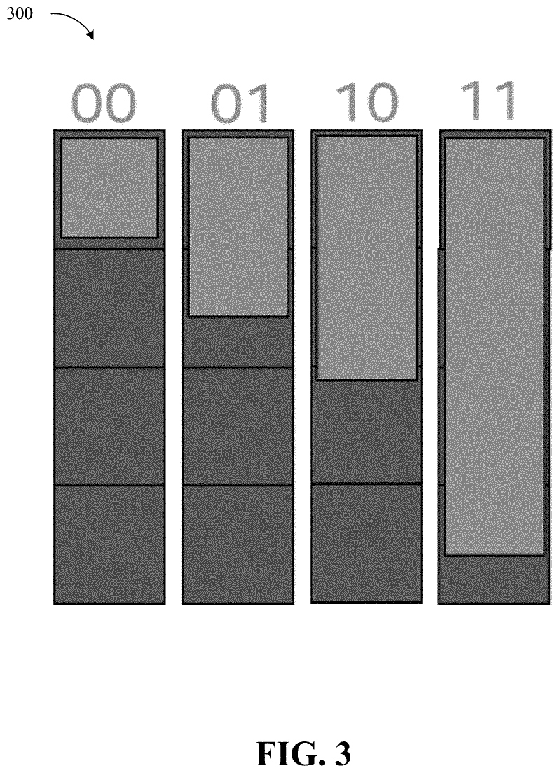

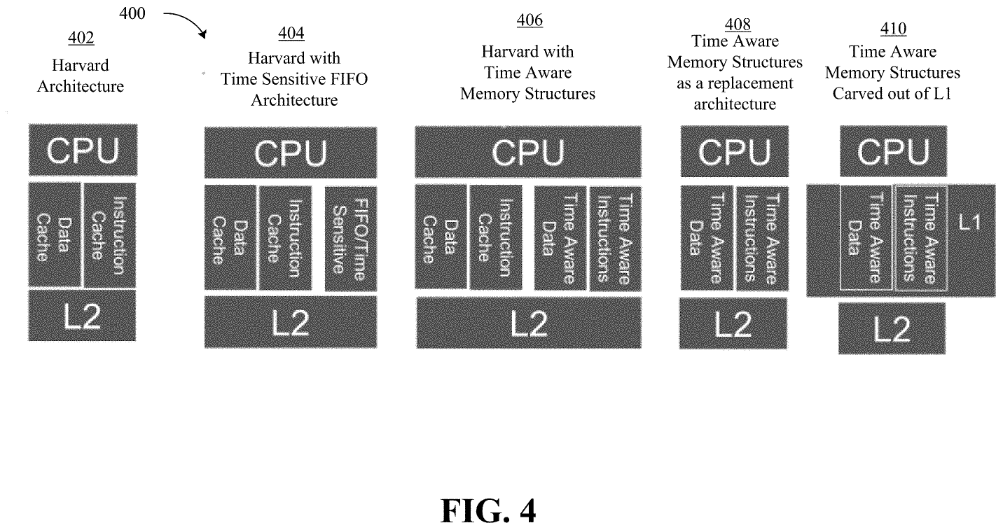

Additional and/or alternative details regarding the computing platform 203 are described in greater detail below in the description of FIGS. 3-4.

FIG. 3 is an illustration of an example memory structure 300 according to an embodiment. As illustrated, FIG. 3 shows how a memory structure 300 near a processor (e.g., a CPU) could act like a FIFO and send back bits indicating how full the memory structure 300 is.

As illustrated, the memory structure 300 In this case 2 bits 00 indicate a <25% available memory structure, 2 bits 01 indicate a <50% available memory structure, 2 bits 10 indicate a <75% available memory structure, and 2 bits 11 indicate a <100% available memory structure. While this figure shows 2 bits being used for this purpose, it could be a single bit (e.g., less than half full and full/almost full) or more than 2 bits. Each section could represent the space for 1K packet's data and/or metadata. Hence in this case, up to 4, 1K packets could be stored, for example. While percentages are described in the examples above, a byte counter could also be used. Also, while the examples illustrate units of 25%, other units could be utilized. For example, on an 8 KB memory structure/cache/FIFO it could show occupancy: 2 bits 00 indicate a >=3.01 KB, 2 bits 01 indicate a >=5.01 KB, 2 bits 10 indicate a >=6.01 KB, and 2 bits 11 indicate a >=7.01 KB.

FIG. 4 is an illustration of example computing platforms 400 according to an embodiment. As illustrated, a Harvard architecture 402 could be adapted to one or more alternative computing platform architectures 404/406/408/410 to allow time-sensitive data to reach the CPU using additional structures like a FIFO or register File, for example. Additionally, or alternatively, different CPUs could be configured differently on the same server. For example, some CPUs may be implemented using a memory structure like computing platform architecture 404 for general purpose processing, while others could be implemented like computing platform architecture 408 for more real-time processing, while still others could be dynamic like computing platform architecture 410 to allow flexibility.

In some implementations, new memory structures associated with alternative computing platform architectures 404/406/408/410 could be part of the cache. These structures associated with alternative computing platform architectures 404/406/408/410 are likely to be required to handle future needs of the data center in terms of performance and latency. The new memory structures associated with alternative computing platform architectures 404/406/408/410 allow Just-in-Time data and instructions to be sent by the IPU or other device, reducing cache misses and improving performance, in some implementations.

In some examples, alternative computing platform architecture 404 shows that a new structure has been added to the Harvard architecture 402 for time sensitive data. For example, such a new structure could be a FIFO or register file directly coupled to the CPU. Such a structure could be designed such that the CPU could access the Time Sensitive memory in a single CPU cycle. Such an example could be even faster than the L1 cache access time. Such an example could have a dedicated interface to the CPU, or share the cache interface(s), for example.

In some implementations, alternative computing platform architecture 406 shows a time aware instruction structure and a time aware data structure. For example, such a time aware instruction structure and a time aware data structure are capable of allowing dedicated memories for time sensitive data. Such structures are capable of allowing higher performance, with the ability to store important data in the cache after the important data has been removed by the CPU from the Time Aware Memories. In some examples, it may be possible that the data is evicted from the Time Aware memory to the normal cache.

In some examples, alternative computing platform architecture 408 shows that time aware instruction and data structure are capable of replacing the cache structures. Such a solution would allow for high performance on data as it streams into CPU.

In some implementations, alternative computing platform architecture 410 shows that an L1 cache can be dynamically configured to have time aware structure as part of the cache memory. This is a feature that might be of particular use in a general purpose processor. In one case, there could be no time aware instructions and data area, which would be similar to what currently exists in general purpose processors (e.g., where there is typically a 50% data cache, and a 50% instruction cache, with 0% time aware). In an extreme case, the cache could be 100% Time aware (e.g., for real-time or video processing). In the middle area, the area assigned to the Time Aware, could be dynamically adjusted based on the processing at that time (e.g., a 50% Time Aware Data, a 0% Time Aware cache, a 40% Normal Instruction Cache, and a 10% Normal Data cache).

When implementing Just-In-Time structures (e.g., like the Time-Aware, Time Sensitive structures as part of the cache), the cache management system will be aware of this functionality and the locations of memories being used. Hence, one or more time aware algorithms will be utilized to control these structures. For example, such time aware algorithms will understand how to evict items base on a precise time. In the case of a FIFO or register file, such time aware algorithms will understand when items have been consumed out of the memory structure, so that other data can be added. In the example of the FIFO, the cache memory management unit/system could track current occupancy. Such operations are technically significant, as existing memory management units/systems don't typical have a concept of managing non-cache memory structures, like FIFOs.

Additionally, or alternatively, while only a single cache is shown in computing platform architecture 410, there could be multiple cache structures that allow dynamically changing between typical cache structures and time aware cache structures.

FIG. 5 shows an example method 500 for packet processing between a consumer and a producer according to an embodiment. The method 500 may generally be implemented in computing system, such as, for example, the computing platform 100 (e.g., see FIG. 1), the computing platform 203 (e.g., see FIG. 2), and/or the computing platforms 404/406/408/410 (e.g., see FIG. 4), already discussed.

More particularly, the method 500 (as well as method 600 (FIG. 6) may be implemented in one or more modules as a set of logic instructions stored in a machine- or computer-readable storage medium such as random access memory (RAM), ROM, programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 500 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 502 provides for receiving, via a producer device, an incoming message including a hint from a consumer device. For example, the hint includes one or more of buffer space type data or buffer space available data and is communicated through a bi-directional stream.

In some examples, the hint includes one or more of: a rate, a rate adjustment, an occupancy level, a credit return, the like, and/or combinations thereof.

In some implementations, the consumer device includes a memory centric device, where the memory centric device has one or more of a cache, a time-aware memory, a FIFO connected to a processor, a register file connected to the processor, the like, and/or combinations thereof. For example, memory centric devices to bridge a gap between compute and memory. Memory centric devices may involve different types of memory-centric architecture. In some examples, memory centric devices move computing resources to the memory side. In such an example, an in-memory computing scheme explores larger bandwidth and reduces data movement overhead. In other examples, memory centric devices include a memory-rich accelerator architecture, which is designed with tightly coupled high performance computing resource and large-capacity on-die memory.

Additionally, or alternatively, the consumer device includes a memory centric device, where the memory centric is structured to implement one or more of a FIFO from a cache memory, a time-aware memory from the cache memory, a register file structure from the cache memory, the like, and/or combinations thereof, for example.

In some examples, the consumer device has a Peripheral Component Interconnect (PCI) interface, a Compute Express Link (CXL) interface, a Peripheral Component Interconnect Express (PCIe) interface, an ethernet interface, a double data rate (DDR) memory interface, the like, and/or combinations thereof.

Illustrated processing block 504 provides for adjusting a transfer rate of outgoing messages communicated through the bi-directional stream. For example, the producer (e.g., a network interface device) adjusts the transfer rate of outgoing messages communicated through the bi-directional stream in response to the hint.

Various implementation alternatives for method 500 are discussed in further detail below.

Hint from the CPU to the IPU

In some implementations, for each bi-directional stream (e.g., IPU queue) between the processor 104 (e.g., CPU) and the network interface device 102 (e.g., IPU), a hint is added to a message going to the network interface device that indicate the buffer space type (fast/slow) and size available for messages incoming from the network interface device. Such operations will allow the network interface device to increase or decrease the rate of incoming data to try to maximize the buffer space and minimize the risk of overflow or underflow, for example.

In some examples, the stream connection comprises a PCI connection, a CXL connection, or a PCIe connection, the like, and/or combinations thereof.

In some implementations, as used herein the term “buffer space” refers to one or more of a FIFO buffer space type, a time aware cache buffer space type, a register file buffer space type, part of a cache buffer space type, an L1 cache buffer space type, part of the L1 cache buffer space type, configured out of the L1 cache buffer space type, an L2 cache buffer space type, part of the L2 cache buffer space type, configured out of the L2 cache buffer space type, the like, and/or combinations thereof.

In some examples, as used herein the term “time-aware cache buffer space” and “time-aware” refers to a cache that does one or more of the following: uses time as part of its cache algorithm calculations, uses time as method to evict a cache entry, uses time as at least one factor in a cache eviction determination, uses time as a method to determine throughput or a rate, uses time as a method of partitioning the cache, uses time as a method to determine incoming data rates to the cache, uses time as a methods to determine processing rates of data in the cache or a portion of the cache or memory structure associated with the cache, uses time as a factor in which level of cache or memory structure is used, uses similar ways of considering time by a buffer space, the like, and/or combinations thereof.

In some examples, the buffer space holds information comprising data, instructions, the like, and/or combinations thereof.

In some examples, the buffer space can be accessed over the same wires as the cache.

In some implementations, the buffer space can be configured as: cache, a FIFO, a time aware memory, the like, and/or combinations thereof. In some examples, the buffer space is configured into two or more FIFOs. In some implementations, the buffer space is configured into two or more time-aware memories

In some examples, the buffer space is controlled by a time-aware algorithm. In some implementations, the time aware algorithm is implemented: in the same chip as the network interface device, the time aware algorithm is implemented in a different chip than the network interface device, a portion of the time aware algorithm is implemented in the same chip as the network interface device, and/or a portion of the time aware algorithm is implemented in a different chip than the network interface device.

In some implementations, the time aware algorithm paces data to the buffer space. For example, the time aware algorithm paces data based on the hints from the CPU.

Additionally, or alternatively, the hints from the CPU about the cache utilization is used to pace the traffic to the CPU chip or chiplet.

In some examples, the hints from the CPU: indicate a FIFO's utilization, indicate a register files utilization, indicate an L1 cache's availability, indicate an L2 cache's availability, indicate cache's availability beyond L1 or L2, the like, and/or combinations thereof.

Additionally, or alternatively, the hint from the CPU is used to pace data to the memory.

In some implementations, the hint is used for: reducing the risk of overflowing a memory, reducing the risk of underflowing a memory, pacing data to the cache, reducing the risk of overflowing a cache, reducing the risk of underflowing a cache, the like, and/or combinations thereof.

Hint from the CPU's Memory Management Unit

In some examples, a hint from the CPU's memory management unit on the occupancy of a low-level memory structure like a L1 cache, L2 cache, register file or FIFO, or the like, is utilized.

In some implementations, the hint is communicated: over PCI, over CXL, over PCIe, the like, and/or combinations thereof.

In some examples, the hint is used for pacing data to the memory.

In some implementations, the hint is used for: reducing the risk of overflowing a memory and/or reducing the risk of underflowing a memory.

In some examples, the CPU's memory management unit manages at least one cache, at least one register files, at least one FIFO, the like, and/or combinations thereof.

In some implementations, the CPU's memory management unit dynamically manages: a cache that can be split into a FIFO structure, a cache that can be split into more than one FIFO structures, a cache that can be split into a register file structures, a cache that can be split into more than one register file structures, a cache that can be split into a time-aware memory, a cache that can be split into more than one time-aware memories, the like, and/or combinations thereof.

In some examples, the occupancy level is measured with two bits, three bits, 8 or fewer bits, and/or the like.

In some implementations, the cache measured is an L1 cache, an L2 cache, a last level cache, and/or the like

Hint Between a Memory Centric Device and the IPU

In some examples, a hint between a memory centric device and an IPU/NIC that allow occupancy levels to be communicated, is utilized.

In some implementations, the memory centric device has: a CXL interface, a PCI or PCIe interface, an ethernet interface, a DDR memory interface, the like, and/or combinations thereof.

In some examples, the memory centric device has more than one chiplet.

In some implementations, the memory centric device has: a cache, a time-aware memory, a FIFO connected to a processor, a register file connected to a processor, the like, and/or combinations thereof.

In some examples, the memory centric device can be structured to implement: a FIFO from a cache memory, a time-aware memory from a cache memory, a register file structure from a cache memory, the like, and/or combinations thereof.

In some implementations, the memory centric device implements a time-aware algorithm.

In some examples, the hint is used for: pacing data to the memory centric device, reducing the risk of overflowing a memory centric device, reducing the risk of underflowing a memory centric device, the like, and/or combinations thereof.

In some implementations, the hint is: a rate, a rate adjustment, a credit return, the like, and/or combinations thereof.

In some examples, such a credit return is implementable as a single bit per cache location (e.g., 64 bit, 32 bits, other bit width, etc.), a single FIFO entry, a portion of the memory (e.g., ¼, ½, ¾, etc.). In implementations where the hint is a credit return, such a credit return would be utilized in a cache based system or in a DDIO type system. For example, such a credit return would be utilized in a tightly coupled CPU memory system (e.g., cache, register file, etc.) that has a credit return.

It will be appreciated that some or all of the operations in method 500 (as well as method 600 (FIG. 6) are described using a “pull” architecture (e.g., polling for new information followed by a corresponding response) may instead be implemented using a “push” architecture (e.g., sending such information when there is new information to report), and vice versa.

Additional and/or alternative operations for method 500 are described in greater detail below in the description of FIG. 6.

FIG. 6 is a flowchart of an example of another method 600 packet processing between a consumer and a producer according to an embodiment. The method 500 may generally be implemented in computing system, such as, for example, the computing platform 100 (e.g., see FIG. 1), the computing platform 203 (e.g., see FIG. 2), and/or the computing platforms 404/406/408/410 (e.g., see FIG. 4), already discussed.

In the illustrated example, method 600 may be implemented via a producer (e.g., a network interface device 102) in communication with a memory architecture 106 and/or communicatively coupled to a consumer device (e.g., a processor 104 of a server).

In some examples, the network interface device 102, the processor 104, and/or the memory architecture 106 include logic 125. The logic 125 is implementable via transistor array, other integrated circuit/IC components, the like, and/or combinations thereof. Additionally, or alternatively, the logic 125 is implementable in one or more modules as a set of logic instructions stored in a machine- or computer-readable storage medium such as random access memory (RAM), ROM, programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, the logic 125 is integrated onto a semiconductor die, as will be discussed in greater detail below with respect to FIG. 7.

Illustrated processing block 602 provides for receiving an incoming message including a hint. For example, the network interface device 102 may receive an incoming message including a hint from the processor 104 of a server via a bi-directional stream. In some implementations the hint includes one or more of buffer space type data or buffer space available data.

Illustrated processing block 604 provides for adjusting a transfer rate of outgoing messages. For example, the network interface device 102 is to adjust a transfer rate of outgoing messages via the bi-directional stream in response to the hint.

In some implementations, the network interface device 102 is to receive a plurality of incoming messages including a plurality of hints from the processor 104 of the server via a plurality of bi-directional streams on a stream-by-stream basis. For example, the plurality of hints include buffer space type data and buffer space available data. In response to the plurality of hints, the network interface device 102 is to adjust a plurality of transfer rates of outgoing messages via the plurality of bi-directional streams on the stream-by-stream basis.

In some examples the adjusted transfer rate is to pace the outgoing messages to one or more of: the processor of the server, a buffer space associated with the processor of the server, or a memory associated with the processor of the server.

Illustrated processing block 606 provides for sending a feedback hint. For example, the network interface device 102 is to send a feedback hint in one or more of the outgoing messages to the processor 104 of the server. In some examples the feedback hint contains information for rate matching operations of the processor 104 of the server to the network interface device 102. In some implementations the feedback hint is based on the adjusted transfer rate.

In some implementations, the feedback hint is capable of helping the processor/memory management unit to dynamically allocate time aware memory/FIFO size. For example, the feedback hint is capable of helping the processor/memory management unit to dynamically allocate an increase in the memory size in response to a higher quantity of arriving/expected data. Conversely, the feedback hint is capable of helping the processor/memory management unit to dynamically allocate a decrease in the memory size in response to a lower quantity of arriving/expected data. In some examples, the feedback hint is capable of triggering the initialization of the cache memory and/or setting up storage structures.

Illustrated processing block 608 provides for performing rate matching. For example, the processor 104 of the server is to perform rate matching in response to the feedback hint.

In some implementations, the buffer space includes one or more of: a first in first out buffer space type, a time aware cache buffer space type, a register file buffer space type, part of a cache buffer space type, an L1 cache buffer space type, part of the L1 cache buffer space type, buffer space configured out of the L1 cache buffer space type, an L2 cache buffer space type, part of the L2 cache buffer space type, buffer space configured out of the L2 cache buffer space type, the like, or combinations thereof.

In some examples, the bi-directional stream includes a Peripheral Component Interconnect (PCI) connection, a Compute Express Link (CXL) connection, or a Peripheral Component Interconnect Express (PCIe) connection, the like, or combinations thereof.

In some implementations, the network interface device includes a network interface controller (NIC), a smart network interface controller (SmartNIC), an Infrastructure Processing Unit (IPUs), or a Data Processing Unit (DPU), the like, or combinations thereof.

In some examples, one or more of the outgoing messages include one or more of data or instructions.

Illustrated processing block 622 provides for sending an outgoing message including a hint. For example, the memory architecture 106 communicatively coupled to the processor 104 of the server is to send an outgoing message including a hint to the network interface device v102 via a bi-directional stream. In some examples the hint includes one or more of buffer space type data or buffer space available data.

In some implementations, the buffer space available data is communicated with only two bits, only three bits, only eight bits, and/or the like.

In some implementations, the buffer space includes one or more of: a first in first out buffer space type, a time aware cache buffer space type, a register file buffer space type, part of a cache buffer space type, an L1 cache buffer space type, part of the L1 cache buffer space type, buffer space configured out of the L1 cache buffer space type, an L2 cache buffer space type, part of the L2 cache buffer space type, buffer space configured out of the L2 cache buffer space type, the like, and/or combinations thereof.

Illustrated processing block 624 provides for receiving an incoming message associated with an adjusted transfer rate. For example, the memory architecture 106 is to receive an incoming message from the network interface device 102 via the bi-directional stream, where the incoming message is associated with an adjusted transfer rate of incoming messages from the network interface device 102 in response to the hint.

In some implementations the memory architecture 106 is to send a plurality of outgoing messages including a plurality of hints via a plurality of bi-directional streams on a stream-by-stream basis. In such implementations, the plurality of hints include buffer space type data and buffer space available data. The memory architecture 106 is to receive a plurality of incoming messages from the network interface device via the plurality of bi-directional streams, where the plurality of incoming messages are associated with a plurality of adjusted transfer rates of incoming messages from the network interface device in response to the plurality of hints on the stream-by-stream basis.

In some examples, the adjusted transfer rate is to pace messages to one or more of: the processor of the server, a buffer space associated with the processor of the server, or a memory associated with the processor of the server, the like, and/or combinations thereof.

Illustrated processing block 626 provides for receiving a feedback hint. For example, the memory architecture 106 is to receive a feedback hint in one or more of the incoming messages from the network interface device, where the feedback hint is based on the adjusted transfer rate.

Illustrated processing block 628 provides for performing rate matching. For example, the memory architecture 106 is to perform rate matching with respect to the network interface device in response to the feedback hint.

In some examples, the memory architecture includes a memory management unit, where in the memory management unit is to: dynamically manage one or more of: a first cache that can be split into a FIFO structure, a second cache that is capable of being split into more than one FIFO structures, a third cache that is capable of being split into a register file structures, a fourth cache that is capable of being split into more than one register file structures, a fifth cache that is capable of being split into a time-aware memory, a sixth cache that is capable of being split into more than one time-aware memories, the like, and/or combinations thereof.

Additional details regarding the various implementations of method 600 are discussed below with regard to FIG. 7.

FIG. 7 shows a semiconductor apparatus 700 (e.g., chip and/or package). The illustrated apparatus 700 includes one or more substrates 702 (e.g., silicon, sapphire, gallium arsenide) and logic 704 (e.g., transistor array and other integrated circuit/IC components) coupled to the substrate(s) 702. In an embodiment, the logic 704 implements one or more aspects of the method 500 (FIG. 5) and/or the method 600 (FIG. 6), already discussed.

In one example, the logic 704 includes transistor channel regions that are positioned (e.g., embedded) within the substrate(s) 702. Thus, the interface between the logic 704 and the substrate 702 may not be an abrupt junction. The logic 704 may also be considered to include an epitaxial layer that is grown on an initial wafer of the substrate 702.

### ADDITIONAL NOTES AND EXAMPLES

Example 1 includes a network interface device comprising: one or more substrates; and a logic coupled to the one or more substrates. The logic is implemented at least partly in one or more of configurable or fixed-functionality hardware, the logic to: receive an incoming message including a hint from a processor of a server via a bi-directional stream, wherein the hint includes one or more of buffer space type data or buffer space available data; and adjust a transfer rate of outgoing messages via the bi-directional stream in response to the hint.

Example 2 includes the network interface device of example 1, wherein the logic is to: receive a plurality of incoming messages including a plurality of hints from the processor of the server via a plurality of bi-directional streams on a stream-by-stream basis, wherein the plurality of hints include buffer space type data and buffer space available data; and adjust a plurality of transfer rates of outgoing messages via the plurality of bi-directional streams in response to the plurality of hints on the stream-by-stream basis.

Example 3 includes the network interface device of any one of examples 1 to 2, wherein the adjusted transfer rate is to pace the outgoing messages to one or more of: the processor of the server, a buffer space associated with the processor of the server, or a memory associated with the processor of the server.

Example 4 includes the network interface device of any one of examples 1 to 3, wherein the logic is to: send a feedback hint in one or more of the outgoing messages to the processor of the server, wherein the feedback hint contains information for rate matching operations of the processor of the server to the network interface device, and wherein the feedback hint is based on the adjusted transfer rate.

Example 5 includes the network interface device of any one of examples 1 to 4, wherein the buffer space comprises one or more of: a first in first out buffer space type, a time aware cache buffer space type, a register file buffer space type, part of a cache buffer space type, an L1 cache buffer space type, part of the L1 cache buffer space type, buffer space configured out of the L1 cache buffer space type, an L2 cache buffer space type, part of the L2 cache buffer space type, or buffer space configured out of the L2 cache buffer space type.

Example 6 includes the network interface device of any one of examples 1 to 5, wherein the bi-directional stream comprises a Peripheral Component Interconnect (PCI) connection, a Compute Express Link (CXL) connection, or a Peripheral Component Interconnect Express (PCIe) connection.

Example 7 includes the network interface device of any one of examples 1 to 6, wherein the network interface device is a network interface controller (NIC), a smart network interface controller (SmartNIC), an Infrastructure Processing Unit (IPUs), or a Data Processing Unit (DPU).

Example 8 includes the network interface device of any one of examples 1 to 7, wherein one or more of the outgoing messages include one or more of data or instructions.

Example 9 includes a system comprising: a processor of a server; and a memory architecture communicatively coupled to the processor of the server. The memory architecture including logic coupled to one more substrates, wherein the logic is to: send an outgoing message including a hint to a network interface device via a bi-directional stream, wherein the hint includes one or more of buffer space type data or buffer space available data; and receive an incoming message from the network interface device via the bi-directional stream, wherein the incoming message is associated with an adjusted transfer rate of incoming messages from the network interface device in response to the hint.

Example 10 includes the system of example 9, wherein the logic is to: send a plurality of outgoing messages including a plurality of hints via a plurality of bi-directional streams on a stream-by-stream basis, wherein the plurality of hints include buffer space type data and buffer space available data; and receive a plurality of incoming messages from the network interface device via the plurality of bi-directional streams, wherein the plurality of incoming messages are associated with a plurality of adjusted transfer rates of incoming messages from the network interface device in response to the plurality of hints on the stream-by-stream basis.

Example 11 includes the system of any one of examples 9 to 10, wherein the adjusted transfer rate is to pace messages to one or more of: the processor of the server, a buffer space associated with the processor of the server, or a memory associated with the processor of the server.

Example 12 includes the system of any one of examples 9 to 10, wherein the logic is to: receive a feedback hint in one or more of the incoming messages from the network interface device, wherein the feedback hint is based on the adjusted transfer rate; and perform rate matching with respect to the network interface device in response to the feedback hint.

Example 13 includes the system any one of examples 9 to 12, wherein the buffer space comprises one or more of: a first in first out buffer space type, a time aware cache buffer space type, a register file buffer space type, part of a cache buffer space type, an L1 cache buffer space type, part of the L1 cache buffer space type, buffer space configured out of the L1 cache buffer space type, an L2 cache buffer space type, part of the L2 cache buffer space type, or buffer space configured out of the L2 cache buffer space type.

Example 14 includes the system of any one of examples 9 to 13, wherein the memory architecture comprises a memory management unit, where in the memory management unit is to: dynamically manage one or more of: a first cache that can be split into a FIFO structure, a second cache that is capable of being split into more than one FIFO structures, a third cache that is capable of being split into a register file structures, a fourth cache that is capable of being split into more than one register file structures, a fifth cache that is capable of being split into a time-aware memory, or a sixth cache that is capable of being split into more than one time-aware memories.

Example 15 includes the system of any one of examples 9 to 14, wherein the buffer space available data is communicated with only two bits, only three bits, or only eight bits.

Example 16 includes at least one computer readable medium, comprising a set of instructions, which when executed by a computing device, cause the computing device to: send, via a consumer device, an outgoing message including a hint to a producer device via a bi-directional stream, wherein the hint includes one or more of buffer space type data or buffer space available data; and receive, via the consumer device, an incoming message from the producer device via the bi-directional stream, wherein the incoming message is associated with an adjusted transfer rate of incoming messages from the producer device in response to the hint.

Example 17 includes the at least one computer readable medium of example 16, wherein the hint comprises one or more of: a rate, a rate adjustment, or a credit return.

Example 18 includes the at least one computer readable medium of any one of examples 16 to 17, wherein the consumer device comprises a memory centric device, and wherein the memory centric device has one or more of: a cache, a time-aware memory, a FIFO connected to a processor, or a register file connected to the processor.

Example 19 includes the at least one computer readable medium of any one of examples 16 to 18, wherein the consumer device comprises a memory centric device, and wherein the memory centric is structured to implement one or more of: a FIFO from a cache memory, a time-aware memory from the cache memory, or a register file structure from the cache memory.

Example 20 includes the at least one computer readable medium of any one of examples 16 to 19, wherein the consumer device has a Peripheral Component Interconnect (PCI) interface, a Compute Express Link (CXL) interface, a Peripheral Component Interconnect Express (PCIe) interface, an ethernet interface, or a double data rate (DDR) memory interface.

Example 21 includes a method, comprising: sending, via a consumer device, an outgoing message including a hint to a producer device via a bi-directional stream, wherein the hint includes one or more of buffer space type data or buffer space available data; and receiving, via the consumer device, an incoming message from the producer device via the bi-directional stream, wherein the incoming message is associated with an adjusted transfer rate of incoming messages from the producer device in response to the hint.

Example 22 includes the method of example 21, wherein the hint comprises one or more of: a rate, a rate adjustment, or a credit return.

Example 23 includes the method of any one of examples 21 to 22, wherein the consumer device comprises a memory centric device.

Example 24 includes the method of example 23, wherein the memory centric device has one or more of: a cache, a time-aware memory, a FIFO connected to a processor, or a register file connected to the processor.

Example 25 includes the method of any one of examples 23 to 24, wherein the memory centric is structured to implement one or more of: a FIFO from a cache memory, a time-aware memory from the cache memory, or a register file structure from the cache memory.

Example 26 includes the method of any one of examples 21 to 25, wherein the consumer device has a Peripheral Component Interconnect (PCI) interface, a Compute Express Link (CXL) interface, a Peripheral Component Interconnect Express (PCIe) interface, an ethernet interface, or a double data rate (DDR) memory interface.

Example 27 includes an apparatus comprising means for performing the method of any one of Examples 21 to 26.

Example 22 includes a machine-readable storage comprising machine-readable instructions which, when executed, implement the method of any one of Examples 21 to 26.

Technology described herein therefore is capable of providing a performance-enhanced computing platform to the extent that it may advantageously improve resource utilization (and improve end user experience). For example, technology described herein is advantageously capable of managing CPU (or other consumer device) data to constantly fill a memory area without overflowing into a slower memory or underflowing the same memory when data is available for it. This can lead to Just-in-Time data delivered to the CPU low level cache or memory structure, to minimize or remove cache misses and the performance penalties that may occur with cache misses.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A network interface device comprising:
one or more substrates; and
a logic coupled to the one or more substrates, where the logic is implemented at least partly in one or more of configurable or fixed-functionality hardware, the logic to:
receive an incoming message including a hint from a processor of a server via a bi-directional stream, wherein the hint includes one or more of buffer space type data or buffer space available data; and
adjust a transfer rate of outgoing messages via the bi-directional stream in response to the hint.

2. The network interface device of claim 1, wherein the logic is to:
receive a plurality of incoming messages including a plurality of hints from the processor of the server via a plurality of bi-directional streams on a stream-by-stream basis, wherein the plurality of hints include buffer space type data and buffer space available data; and
adjust a plurality of transfer rates of outgoing messages via the plurality of bi-directional streams in response to the plurality of hints on the stream-by-stream basis.

3. The network interface device of claim 1, wherein the adjusted transfer rate is to pace the outgoing messages to one or more of: the processor of the server, a buffer space associated with the processor of the server, or a memory associated with the processor of the server.

4. The network interface device of claim 1, wherein the logic is to:
send a feedback hint in one or more of the outgoing messages to the processor of the server, wherein the feedback hint contains information for rate matching operations of the processor of the server to the network interface device, and wherein the feedback hint is based on the adjusted transfer rate.

5. The network interface device of claim 1, wherein the buffer space comprises one or more of: a first in first out buffer space type, a time aware cache buffer space type, a register file buffer space type, part of a cache buffer space type, an L1 cache buffer space type, part of the L1 cache buffer space type, buffer space configured out of the L1 cache buffer space type, an L2 cache buffer space type, part of the L2 cache buffer space type, or buffer space configured out of the L2 cache buffer space type.

6. The network interface device of claim 1, wherein the bi-directional stream comprises a Peripheral Component Interconnect (PCI) connection, a Compute Express Link (CXL) connection, or a Peripheral Component Interconnect Express (PCIe) connection.

7. The network interface device of claim 1, wherein the network interface device is a network interface controller (NIC), a smart network interface controller (SmartNIC), an Infrastructure Processing Unit (IPUs), or a Data Processing Unit (DPU).

8. The network interface device of claim 1, wherein one or more of the outgoing messages include one or more of data or instructions.

9. A system comprising:
a processor of a server; and
a memory architecture communicatively coupled to the processor of the server, the memory architecture including logic coupled to one more substrates, wherein the logic is to:
send an outgoing message including a hint to a network interface device via a bi-directional stream, wherein the hint includes one or more of buffer space type data or buffer space available data; and
receive an incoming message from the network interface device via the bi-directional stream, wherein the incoming message is associated with an adjusted transfer rate of incoming messages from the network interface device in response to the hint.

10. The system of claim 9, wherein the logic is to:
send a plurality of outgoing messages including a plurality of hints via a plurality of bi-directional streams on a stream-by-stream basis, wherein the plurality of hints include buffer space type data and buffer space available data; and
receive a plurality of incoming messages from the network interface device via the plurality of bi-directional streams, wherein the plurality of incoming messages are associated with a plurality of adjusted transfer rates of incoming messages from the network interface device in response to the plurality of hints on the stream-by-stream basis.

11. The system of claim 9, wherein the adjusted transfer rate is to pace messages to one or more of: the processor of the server, a buffer space associated with the processor of the server, or a memory associated with the processor of the server.

12. The system of claim 9, wherein the logic is to:
receive a feedback hint in one or more of the incoming messages from the network interface device, wherein the feedback hint is based on the adjusted transfer rate; and
perform rate matching with respect to the network interface device in response to the feedback hint.

13. The system of claim 9, wherein the buffer space comprises one or more of: a first in first out buffer space type, a time aware cache buffer space type, a register file buffer space type, part of a cache buffer space type, an L1 cache buffer space type, part of the L1 cache buffer space type, buffer space configured out of the L1 cache buffer space type, an L2 cache buffer space type, part of the L2 cache buffer space type, or buffer space configured out of the L2 cache buffer space type.

14. The system of claim 9, wherein the memory architecture comprises a memory management unit, where in the memory management unit is to:
dynamically manage one or more of: a first cache that can be split into a FIFO structure, a second cache that is capable of being split into more than one FIFO structures, a third cache that is capable of being split into a register file structures, a fourth cache that is capable of being split into more than one register file structures, a fifth cache that is capable of being split into a time-aware memory, or a sixth cache that is capable of being split into more than one time-aware memories.

15. The system of claim 9, wherein the buffer space available data is communicated with only two bits, only three bits, or only eight bits.

16. At least one computer readable storage medium, comprising a set of instructions, which when executed by a computing device, cause the computing device to:
send, via a consumer device, an outgoing message including a hint to a producer device via a bi-directional stream, wherein the hint includes one or more of buffer space type data or buffer space available data; and
receive, via the consumer device, an incoming message from the producer device via the bi-directional stream, wherein the incoming message is associated with an adjusted transfer rate of incoming messages from the producer device in response to the hint.

17. The at least one computer readable storage medium of claim 16, wherein the hint comprises one or more of: a rate, a rate adjustment, or a credit return.

18. The at least one computer readable storage medium of claim 16, wherein the consumer device comprises a memory centric device, and wherein the memory centric device has one or more of: a cache, a time-aware memory, a FIFO connected to a processor, or a register file connected to the processor.

19. The at least one computer readable storage medium of claim 16, wherein the consumer device comprises a memory centric device, and wherein the memory centric is structured to implement one or more of: a FIFO from a cache memory, a time-aware memory from the cache memory, or a register file structure from the cache memory.

20. The at least one computer readable storage medium of claim 16, wherein the consumer device has a Peripheral Component Interconnect (PCI) interface, a Compute Express Link (CXL) interface, a Peripheral Component Interconnect Express (PCIe) interface, an ethernet interface, or a double data rate (DDR) memory interface.
